(19) United States
(12) Patent Application Publication
(10) Pub. No.: US 2006/0074948 A1
(43) Pub. Date: Apr. 6, 2006

(54) Management server, system, method and program

(75) Inventors: Toshiyasu Motoki, Zama-shi (JP); Izura Narita, Yamato-shi (JP)

Correspondence Address: William A. Kinnaman, Jr.;IBM Corporation - MS P386, 2455 South Road, Poughkeepsie, NY, 12601, US

(73) Assignee: International Business Machines Corporation, Armonk, NY (US)

(21) Appl. No.: 11/242,465

(22) Filed: Oct. 3, 2005

(30) Foreign Application Priority Data
Oct. 4, 2004 (JP) 2004-291242

(51) Int. Cl. G06F 17/30

(52) U.S. Cl. 707/100

(57) ABSTRACT

A management server for managing a group of operation devices includes: a bottleneck information acquisition unit and a server configuration information acquisition unit, both of which are for acquiring information relating to a bottleneck from a device to be managed, the device constituting a group of operation devices, and for storing the information into a storage device; a hardware option information acquisition unit for acquiring information relating to hardware exchangeable for hardware causing the bottleneck, and for storing the information into the storage device; and an information analysis unit for comparing the information relating to the bottleneck and the information relating to the former hardware, each information being stored in the storage device, and for selecting hardware, which is effective in dissolving the bottleneck, out of the hardware whose information has been acquired by the hardware option information acquisition unit.

### CROSS-REFERENCE TO RELATED APPLICATION

This application claims the priority benefit under 35 U.S.C. § 119 of prior Japanese application 2004-291242, filed Oct. 4, 2004, and incorporated herein by reference.

### BACKGROUND OF THE INVENTION

1. Field of the Invention

The present invention relates to a system for managing a device to be managed (hereinafter referred to as “managed device”) by a management server, and more particularly to a management server for monitoring an operation state of the managed device to detect bottlenecks. The invention also relates to a system using the management server.

2. Description of the Related Art

Nowadays, information processing using computers has been executed in various kinds of fields including business. Generally, a system for executing the information processing in organizations such as a business enterprise constructs a distributed system which operates an application and shares a data file while allowing a plurality of computers to cooperate with each other. The distributed system is effective in reducing a load of an individual computer and in realizing a security against loss of the data file, and the like.

The distributed system is architected by a large number of servers such as a Web server, an application server, a DB (database) server, a DHCP (Dynamic Host Configuration Protocol) server, a DNS (Domain Name System) server, a mail server, a file server and a proxy server, which have various functions. Accordingly, it is very important to centrally control the servers clearly. A server for managing the servers exclusively (hereinafter referred to as “management server”) is used to centrally control the servers in the distributed system.

The management server has various functions for realizing an integrated server management, and one of the functions is management of hardware resources of the respective servers. The management of the hardware resources is to automatically analyze long-term usage of the hardware resources used by the servers and to find out bottlenecks of performance of each server. This technology is described for instance in Japanese Published Patent Application 2003-208413.

As described above, the management server of the distributed system has a function to manage the hardware resources of the system and to find out the bottleneck of the performance of each server. However, in an actual operation, how to dissolve such a bottleneck concretely is a problem after the hardware causing the bottleneck, which includes a CPU, a magnetic disc device, a memory and the like, has been found out.

A troublesome work to check whether the hardware causing the bottleneck is exchangeable and hardware having better performance is available (purchasable) and to perform a buying activity if such hardware is present (on the market) needs to be performed. Such a work imposes very heavy burden for a manager of the system. If the hardware causing the bottleneck is not exchanged with other hardware and left for a long time, extreme deterioration of system's performance is brought about afterward, and failure of the system is caused.

On the other hand, from a standpoint of a seller of hardware constituting the system, the long-time neglect of the hardware causing the bottleneck in the system, which should be exchanged, implies loss of chances to sell a hardware option, resulting economic loss.

Accordingly, the present invention is to provide a system which automatically detects hardware causing a bottleneck for performance of the system, and which automatically researches hardware capable of dissolving the bottleneck.

Furthermore, in addition to the above described object, the present invention is to provide a system which automatically purchases hardware capable of dissolving a bottleneck which has been researched, and a method of the same.

### SUMMARY OF THE INVENTION

In order to achieve the above described objects, the present invention is realized as a management server for managing a group of operation devices. A management server is characterized by comprising: a server information acquisition unit which acquires information relating to a bottleneck from a device to be managed, which constitutes the group of the operation devices, and for storing the acquired information in a storage device; a hardware option information acquisition unit which acquires pieces of information on hardware exchangeable for hardware causing the bottleneck and for storing the acquired information in the storage device; and an analysis processing unit which compares the information relating to the bottleneck stored in the storage device with the pieces of information on the hardware, and for determining hardware effective in dissolving the bottleneck among the hardware, the information on which is acquired by the hardware option information acquiring unit.

More specifically, the hardware option information acquisition unit acquires information on hardware usable to the managed unit from which the information relating to the bottleneck is acquired, the hardware being the same kind as the hardware causing the bottleneck. The analysis processing unit selects hardware or a combination thereof, which exercises performance capable of achieving a countermeasure for dissolving the bottleneck, in response to a content of the information relating to the bottleneck acquired by the server information acquisition unit, and determines the hardware effective in dissolving the bottleneck. Furthermore, the server information acquisition unit can be configured to include a bottleneck information acquisition unit which acquires information for specifying the hardware causing the bottleneck and bottleneck information describing a countermeasure effective in dissolving the bottleneck and a server configuration information acquisition unit which acquires configuration information relating to the hardware causing the bottleneck.

To be more preferable, the management server can be configured to further include an output control unit which outputs the information relating to the hardware determined by the analysis processing unit, the information having been acquired by the hardware option information acquisition unit, and notifies the information to a user. The output control unit outputs pieces of enumerated information relating to the hardware when the plurality of hardware items effective in dissolving the bottleneck exists, which relates to the hardware determined by the analysis processing unit. The management server can be configured to include a purchase processing unit which accepts an input operation by a user and transmits a request to purchase the hardware, which is selected by the input operation and effective in dissolving the bottleneck, to the hardware option selling server online.

The hardware option information server which is coupled with the management server through a network, receives information concerning above described hardware. The hardware option information server includes: a hardware information storage unit which stores information relating to hardware which can be used for a device to be managed, the device constituting the group of the operation devices; and an information retrieval unit which receives the transmission request which has been transmitted from the hardware option information acquisition unit of the management server, reads out from the hardware information storage unit information relating to hardware which corresponds to the transmission request, and transmits to the management server the information as a response to the request. The system constituted by the hardware option information server and the management server is grasped as a system which performs an operation automatically to materialize a countermeasure effective in dissolving the bottleneck.

Furthermore, the present invention can also be realized as a program which controls a computer system to function as above described management server. The program is provided by distribution of record media such as magnetic disc, optical disc and semiconductor memory, or by delivery through a network.

According to the present invention configured as described above, the management server can automatically detect the hardware causing the bottleneck for performance in the system, and thereafter can automatically detect the hardware capable of dissolving the bottleneck by accessing the hardware option information server. Thus, it is unnecessary for the user (system manager) to perform a troublesome operation to examine hardware suitable for dissolving the bottleneck, thereby reducing a burden of the user.

Since it becomes easy to research and purchase hardware suitable for dissolving the bottleneck, the long-time neglect of the hardware causing the bottleneck without being exchanged can be avoided, and a system failure due to deterioration of system performance can be prevented in advance.

Furthermore, from a standpoint of a seller of the hardware constituting the system, since information on the hardware options causing the bottleneck in the system, which should be exchanged, can be provided and sold, it is possible to increase chance to sell the hardware option.

### BRIEF DESCRIPTION OF THE DRAWINGS

For a more complete understanding of the present invention and the advantages thereof, reference is now made to the following description taken in conjunction with the accompanying drawings.

FIG. 1 is a diagram showing a total configuration of a distributed system to which an embodiment is applied.

FIG. 2 is a diagram schematically showing an example of a hardware configuration of a computer apparatus suitable for realizing servers in the system of this embodiment.

FIG. 3 is a diagram showing a functional configuration of a system management agent loaded on servers of a group of operation servers in this embodiment.

FIG. 4 is a diagram showing a functional configuration of a management server of this embodiment.

FIG. 5 is a diagram showing a functional configuration of an H/W option information server of this embodiment.

FIG. 6 is a flowchart for explaining an operation of the management server of this embodiment.

FIG. 7 is a diagram for explaining a configuration example of bottleneck information of this embodiment.

FIG. 8 is a diagram showing a configuration example of hardware configuration information of this embodiment.

FIG. 9 is a diagram showing a configuration example of hardware information transmitted from the management server to the H/W option information server in this embodiment.

FIG. 10 is a diagram showing a configuration example of hardware option information of this embodiment.

FIG. 11 is a diagram showing an example of a resource effective in dissolving a bottleneck determined by an information analysis unit of this embodiment.

FIG. 12 is a diagram showing a configuration example of a display screen displayed on a display device by an output control unit of this embodiment.

FIG. 13 is a diagram showing a total configuration of a system in which a second embodiment of the present invention is operated.

FIG. 14 is a diagram showing a functional configuration of a management server of this embodiment.

FIG. 15 is a flowchart for explaining an operation of the management server of this embodiment.

FIG. 16 is a diagram for explaining a configuration example of a display screen displayed on a display device by an output control unit of this embodiment.

### DETAILED DESCRIPTION OF THE PREFERRED EMBODIMENTS

Best modes for carrying out the present invention (hereinafter referred to as “embodiments”) will be described with reference to the accompanying drawings below in detail.

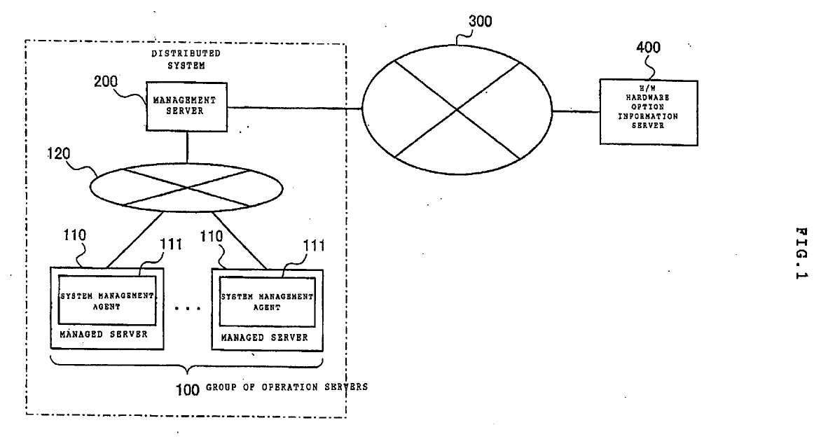

FIG. 1 is a diagram for explaining a total configuration of a system to which this embodiment is applied.

Referring to FIG. 1, the system of this embodiment comprises a group of operation servers 100, which are to be managed; and a management server 200 for managing managed servers 110 to be managed (hereinafter referred to as “managed servers”), which belong to the group of operation servers 100. The management server 200 and the respective managed servers 110 of the group of the operation servers 100 are coupled via a network 120 in the system such as a LAN (Local Area Network). The respective managed servers 110 of the group of the operation servers 100 perform communications with the management server 200, and respectively include a system management agent 111 for exchanging information necessary for the management.

Furthermore, the management server 200 is coupled to a hardware (H/W) option information server 400, which is provided outside the system, via a network 300 such as Internet. The H/W option information server 400 is provided by a maker of the managed servers 110 constituting the group of operation servers 100 of a distributed system, and supplies information relating to a hardware option usable to the managed servers 110 in response to an inquiry from the management server 200. In this embodiment, the management server 200 and the H/W option information server 400 constitute a system which automatically works to materialize a countermeasure for dissolving the bottleneck.

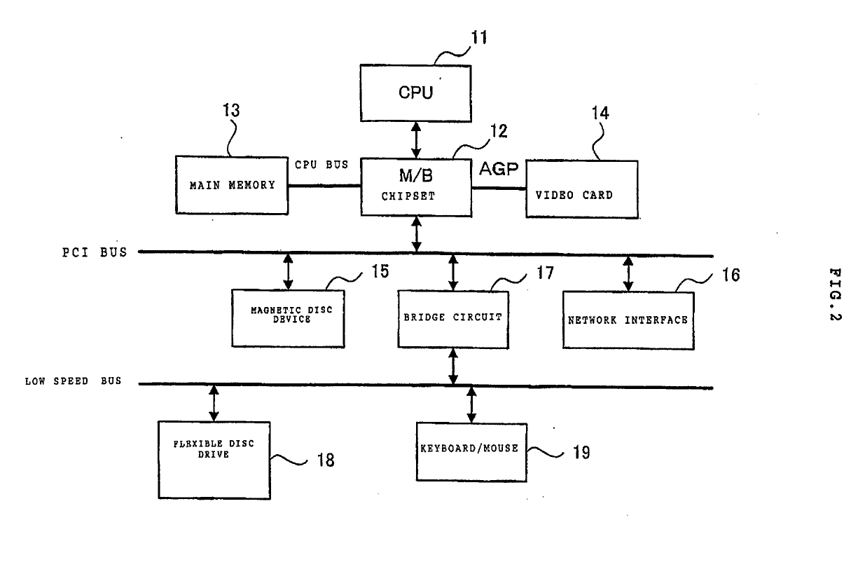

FIG. 2 is a diagram schematically showing an example of a hardware configuration of a suitable computer apparatus as the managed server 110 of the group of operation servers 100, the management server 200 in the system of this embodiment and the H/W option information server 400.

The computer apparatus shown in FIG. 2 comprises a CPU (Central Processing Unit) 11 which is arithmetic means; a main memory 13 coupled to the CPU 11 via an M/B (mother board) chip set 12 and a CPU bus; a video card 14 coupled to the CPU 11 via the M/B chip set 12 and an AGP (Accelerated Graphic Port); a magnetic disc unit (HDD) 15 coupled to the M/B chip set 12 via a PCI (Peripheral Component Interconnect) bus; a network interface 16; and a flexible disc drive 18 and a keyboard/mouse 19, which are coupled to the M/B chip set 12 via PCI bus and a low-speed bus such as an ISA (Industry Standard Architecture) bus.

FIG. 2 merely exemplifies the hardware configuration of the computer apparatus for realizing this embodiment, and the hardware configuration thereof can adopt other various hardware configurations if it is possible to apply this embodiment to the hardware configuration. For example, a hardware configuration of the computer apparatus may be adopted, in which only a video memory is incorporated in the computer apparatus instead of providing the video card 14, and in which image data is processed by the CPU 11. Alternatively, a drive such as a CD-R (Compact Disc Recordable) and a DVD-RAM (Digital Versatile Disc Random Access Memory) may be provided via an interface such as an ATA (At Attachment) and a SCSI (Small Computer System Interface).

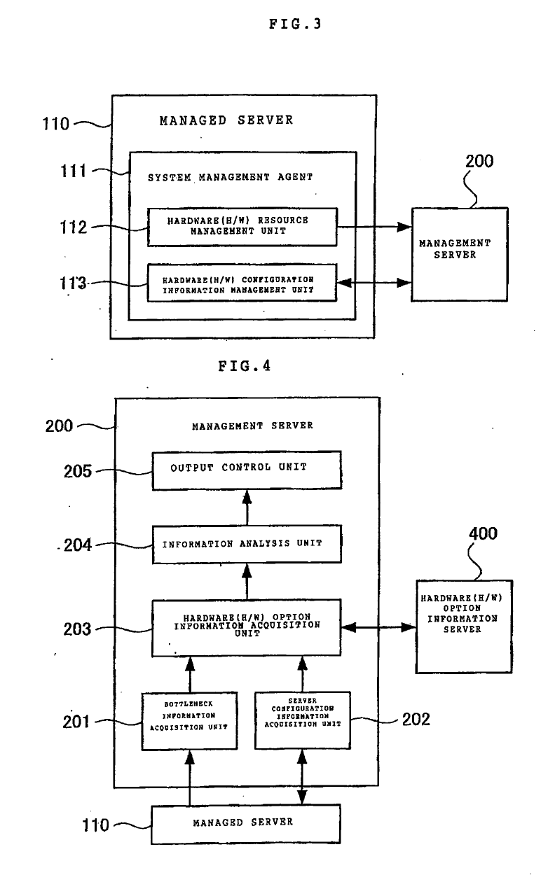

FIG. 3 is a diagram showing a functional configuration of a system management agent 111 incorporated in each of the managed servers 110 of the group of the operation servers 100.

In the case where the respective managed servers 110 are constituted, for example, by the computer apparatus shown in FIG. 2, the system management agent 111 is realized by the CPU 11 controlled by a program and storage devices such as the main memory 13 and the magnetic disc device 15. Referring to FIG. 3, the system management agent 111 includes a hardware (H/W) resource management unit 112 and a hardware (H/W) configuration information management unit 113.

The H/W resource management unit 112 monitors a working state of each of the managed servers 110, and acquires and stores information relating to usage of the hardware, which includes an idle time of a work by the CPU 11 and free space in the main memory 13 and the magnetic disc device 15. When a bottleneck of some kind in terms of performance of each of the managed servers 110 occurs due to an increase in a usage of the CPU 11 and small free space of the magnetic disc device 15, the H/W resource management unit 112 generates bottleneck information, and transmits it to the management server 200.

In the H/W configuration information management unit 113, configuration information on in-use hardware (sort, product name, product number, performance and number of in-use hardware) of the managed server 110 is stored. In response to a request from the management server 200, the H/W configuration information management unit 113 transmits the configuration information on necessary hardware.

FIG. 4 is a diagram showing a functional configuration of the management server 200.

Referring to FIG. 4, the management server 200 includes a bottleneck information acquisition unit 201 and a server configuration information acquisition unit 202, which are means for acquiring information from a managed server 110 belonging to the group of operation servers 100; a hardware (H/W) option information acquisition unit 203; an information analysis unit 204 and an output control unit 205.

In the case where the management server 200 is constituted, for example, by the computer apparatus shown in FIG. 2, the bottleneck information acquisition unit 201 is realized by the network interface 16 and a storage device such as the main memory 13 or the magnetic disc device 15. The bottleneck information acquisition unit 201 receives the bottleneck information sent from the managed server 110 via the network 120, and holds it therein.

The server configuration information acquisition unit 202 is, as shown in FIG. 2, for example, realized by the CPU 11, which is controlled by the program; the storage device such as the main memory 13 or the magnetic disc device 15; and the network interface 16. The server configuration information acquisition unit 202 requests from the managed server 110 via the network 120 the configuration information on the hardware shown in the bottleneck information which has been received by the bottleneck information acquisition unit 201. The server configuration information acquisition unit 202 acquires this information and holds it therein.

The H/W option information acquisition unit 203 is realized by the CPU 11 controlled by the program, the storage device such as the main memory 13 or the magnetic disc device 15, and the network interface 16, for example, which are shown in FIG. 2. The H/W option information acquisition unit 203 accesses an H/W option information server 400, which is provided outside the management server 200, via a network 300. Then, the H/W option information acquisition unit 203 acquires option information on hardware exchangeable for the hardware causing the bottleneck, and holds it therein. The hardware option information indicates hardware of the same kind as the hardware causing the bottleneck and usable by the managed server 110 in which the bottleneck has occurred.

The information analysis unit 204 is realized by the CPU 11 of FIG. 2, for example, which is controlled by the program. The information analysis unit 204 analyses the information acquired by the bottleneck information acquisition unit 201, the server configuration information acquisition unit 202 and the H/W option information acquisition unit 203, and determines an effective hardware option to dissolve the bottleneck that has occurred.

The output control unit 205 is realized by the CPU 11 controlled by the program and the video card 14, for example, which are shown in FIG. 2. The output control unit 205 displays the information relating to the hardware option effective in dissolving the bottleneck that has occurred on a display device, and notifies users (e.g., a system manager).

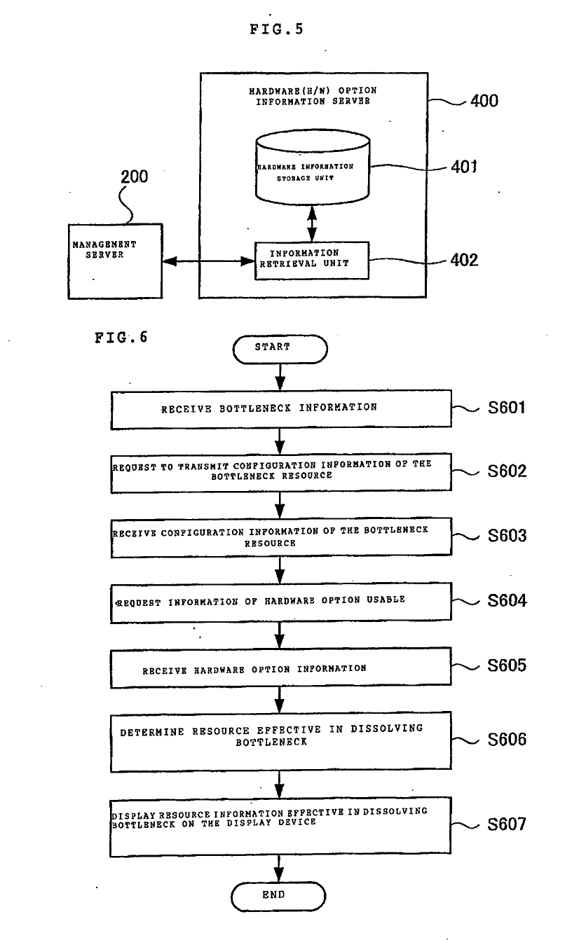

FIG. 5 is a diagram showing a functional configuration of the H/W option information server 400.

As shown in FIG. 5, the H/W option information server 400 includes a hardware information storage unit 401 and an information retrieval unit 402. The hardware information storage unit 401 is realized by the storage device such as the magnetic disc device 15, for example, which is shown in FIG. 2, and stores information relating to hardware usable to each of the managed servers 110 constituting the group of operation servers 100. The information retrieval unit 402 is realized by the CPU 11 controlled by the program, for example, which is shown in FIG. 2. In response to a request transmitted from the management server 200, the information retrieval unit 402 reads out information relating to hardware corresponding to the request from the hardware information storage unit 401, and sends back it to the management server 200.

The H/W option information server 400 is realized merely by performing a function in addition to a coexisting server for providing product information at a site on Internet, which is provided by a maker of hardware. The function added to the coexisting server is one to receive a request described in a certain markup language such as XML and to send back information relating to the hardware in the certain markup language in order to exchange the information with the management server 200. Furthermore, though one H/W option information server 400 is illustrated in FIG. 1, the H/W option information server 400 is provided individually for each managed server 110, a maker of the individual hardware constituting the managed server 110, and a distributor of the hardware. Specifically, in accordance with sorts of the managed server 110 and the bottleneck resource, in which the bottleneck has occurred, the management server 200 explores an H/W option information server 400 provided by the maker and the distributor, and accesses it, thus acquiring information on desired hardware.

Next, an operation of the distributed system of this embodiment, which is configured as described above, will be described.

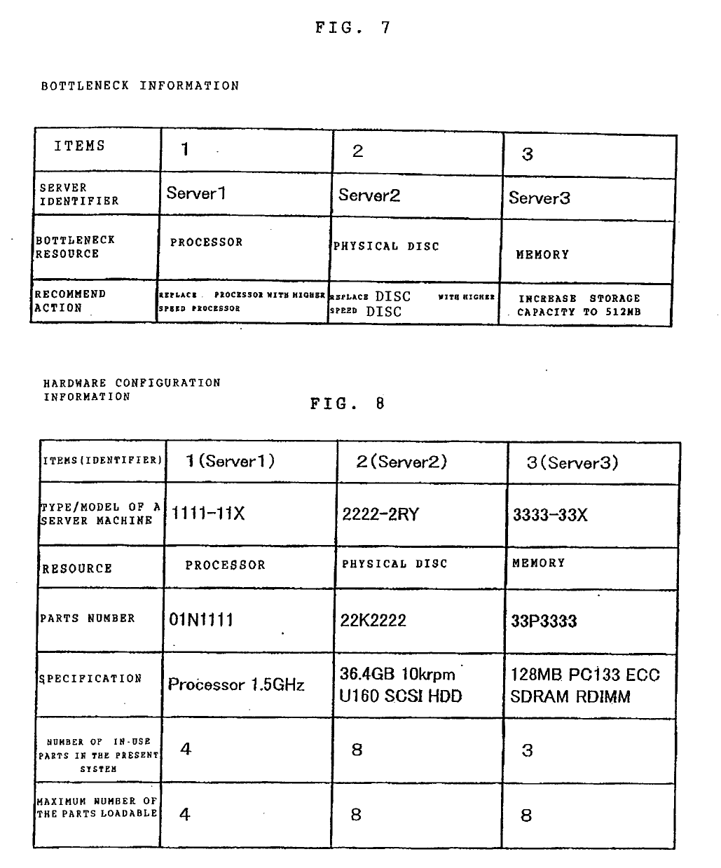

FIG. 6 is a flowchart for explaining an operation of the management server 200 of this embodiment.

In the distributed system of this embodiment, the H/W resource management unit 112 monitors an operation of the managed server 110 to which the unit 112 belongs. If the bottleneck has occurred, the H/W resource management unit 112 generates bottleneck information, and outputs it.

FIG. 7 is a diagram showing a configuration example of the bottleneck information.

Referring to FIG. 7, information relating to a server identifier, a bottleneck resource and a recommended action is registered in the bottleneck information for each bottleneck detected by the H/W resource management unit 112 of the system management agent 111. Herein, the server identifier is information for identifying a server in which the bottleneck occurs. The bottleneck resource is information indicating hardware which is the bottleneck itself. The recommended action is a countermeasure effective in dissolving the bottleneck. Messages of the recommended action are previously written in accordance with the type of hardware, the system configuration of the managed server 110, the state of the bottleneck and the like, and are stored in the storage device of the managed server 110 in advance. A relevant message is read out depending on the content of the bottleneck detected by the H/W resource management unit 112, and registered in the bottleneck information. For example, in Item 1 of FIG. 7, information that, with respect to the managed server 110 specified by a server identifier Server 1, a processor is a bottleneck resource and a replacement of the processor with a higher-speed processor is effective in dissolving the bottleneck is registered.

As shown in FIG. 6, the bottleneck information acquisition unit 201 of the management server 200 receives bottleneck information outputted from the H/W resource management unit 112 of each managed server 110, which is illustrated in FIG. 7, and stores and holds it in the storage device (Step 601). When the bottleneck information is acquired by the bottleneck information acquisition unit 201, the server configuration information acquisition unit 202 requests the managed server 110, which has transmitted the bottleneck information, to transmit configuration information on the bottleneck resource thereto (Step 602). When the system management agent 111 of the managed server 110 receives the transmission request, the system management agent 111 thereof sends back the configuration information on the hardware (bottleneck resource), which is an object to be transmitted, to the management server 200 through the H/W configuration information management unit 113.

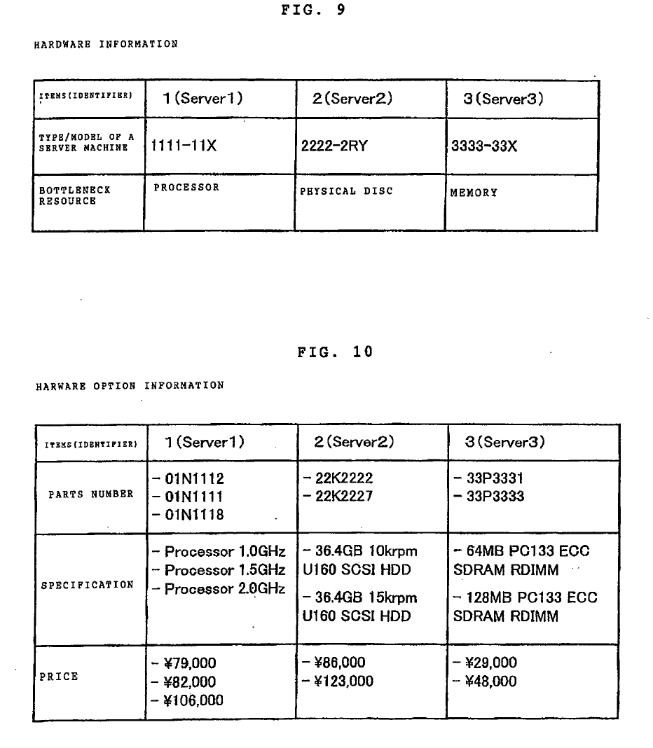

FIG. 8 is a diagram showing a configuration example of the hardware configuration information.

Referring to FIG. 8, with respect to the hardware configuration information, information relating to the type/model of server machine, a resource (type of hardware), a part number (product number), a specification, the number of in-use parts in the present system and the maximum number of the parts loadable is registered. For example, concerning Item 1 of FIG. 8, the configuration information relating to the processor which is the bottleneck resource in FIG. 7 is registered with respect to the managed server 110 of the server identifier Server 1. Specifically, information indicating that the type/model of the server machine is 1111-11X, the part number of the processor is 01N1111, the clock speed of the processor is 1.5 GHz, four such processors are loaded on the present system, and the maximum number of the parts loadable on the system is four is registered.

The server configuration information acquisition unit 202 receives the hardware configuration information as shown in FIG. 8, which is outputted from the H/W configuration information management unit 113 of the managed server 110, and stores it in the storage device (Step 603). When the hardware configuration information is received by the server configuration information acquisition unit 202, the H/W option information acquisition unit 203 accesses the H/W option information server 400. Subsequently, the H/W option information acquisition unit 203 transmits information for specifying a server machine and a resource (a type of hardware) and performs a transmission of a request for information relating to a hardware option usable instead of the resource in the server machine (Step 604). The request is written in a markup language to which the H/W option information server 400 corresponds, for example, XML.

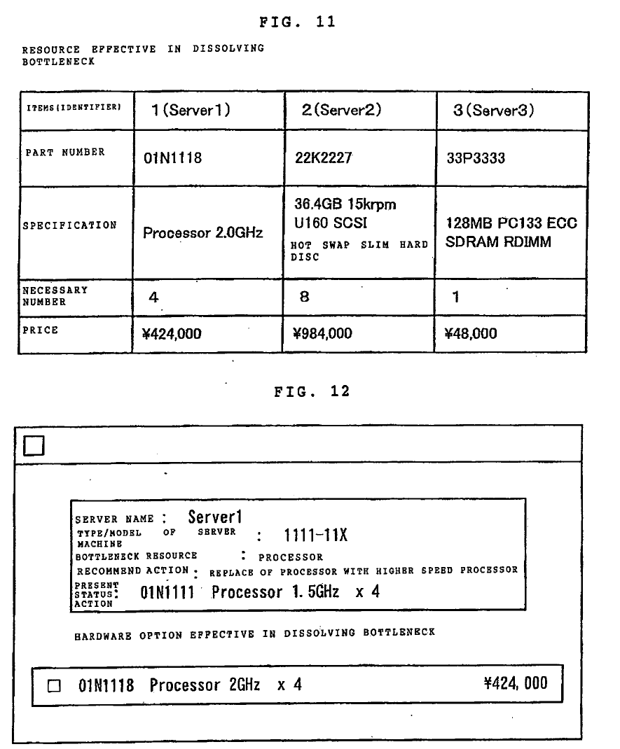

FIG. 9 is a diagram showing a configuration example of the hardware information transmitted from the management server 200 to the H/W option information server 400.

In FIG. 9, for example, in Item 1, information that a type/model of the server machine of the managed server 110 is 1111-11X and the resource is a processor is registered.

When the H/W option information server 400 receives the transmission request in which the hardware information as shown in FIG. 9 is described, based on the information relating to the type/model of the server machine and the resource described in this transmission request, the H/W option information server 400 sends back the information (hardware option information) of the resource usable to the server machine to the management server 200.

FIG. 10 is a diagram showing a configuration example of the hardware option information.

Referring to FIG. 10, in the hardware option information, a part number of a resource usable to a server machine, a specification and a price are registered for each resource relevant to the transmission request. For example, in Item 1 of FIG. 10, information is registered, in which there are three kinds of processors as ones usable to the server machine 1111-11X registered in the Item 1 of FIG. 9; a processor having a part number 01N1112 has a clock speed of 1.0 GHz and is 79,000 Yen; and a processor having a part number 01N1111 has a clock speed of 1.5 GHz and is 82,000 Yen; and a processor having a part number 01N118 has a clock speed of 2 GHz and is 106,000 Yen.

The H/W option information acquisition unit 203 receives the hardware option information, which is illustrated in FIG. 10 and transmitted from the H/W option information server 400, and stores and holds it in the storage device (Step 605).

Next, based on the bottleneck information and the hardware configuration information, the information analysis unit 204 determines a resource effective in dissolving the bottleneck out of the resources described in the hardware option information (Step 606). For example, referring to Item 1 in FIGS. 7, 8 and 10, the recommended action to the effect that the processor is replaced for a higher-speed processor is described in the bottleneck information. Furthermore, according to the hardware configuration information, the processor used in the managed server 110 in the present has the part number 01N1111 and has a clock speed of 1.5 GHz. Accordingly, when a higher-speed processor than the processor having the part number 01N1111 is searched in the hardware option information, it is found that the processor having the part number 01N1118 (clock speed: 2 GHz) is relevant to it. Therefore, this processor is determined as a resource effective in dissolving the bottleneck in the Item 1.

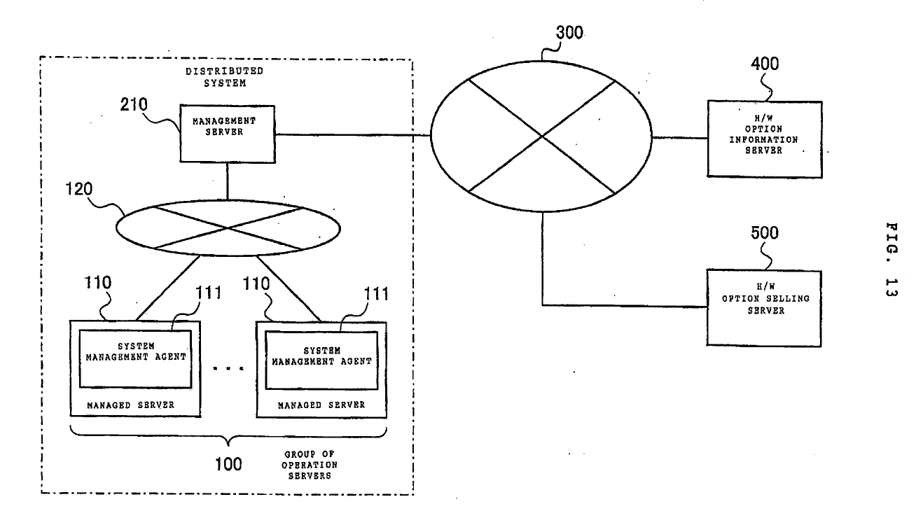

FIG. 11 is a diagram showing an example of information relating to the resource (hardware option) effective in dissolving the bottleneck determined by the information analysis unit 204.

Referring to FIG. 11, with respect to the foregoing Item 1, information relating to a processor effective in dissolving the bottleneck, which includes a part number, a specification, the necessary number and a price (total amount), is described. Similarly, with respect to Item 2, information relating to a higher-speed physical disc device than the physical disc (magnetic disc) device used in the present, which includes a part number: 22K2227, a specification: 36.4 GB 15 krpm U160 SCSI hot swap slim hard disc, a necessary number: 8, and a price: 984,000 Yen, is described. Furthermore, with respect to Item 3, information relating to a memory necessary to increase storage capacity to 512 MB, which includes a part number: 33P3333, a specification: 128 MB PC133 ECC SDRAM RDIMM, a necessary number: 1, and a price: 48,000 Yen, is described.

Next, the output control unit 205 displays the information relating to the resource effective in dissolving the bottleneck, which has been determined by the information analysis unit 204, on the display device (Step 607).

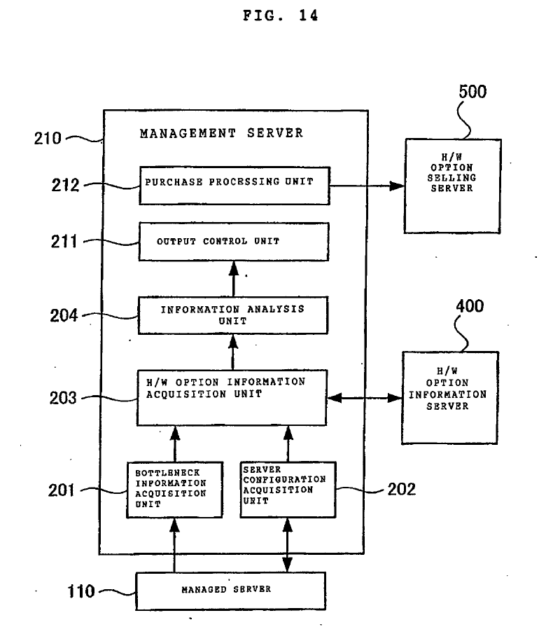

FIG. 12 is a diagram showing a configuration example of a display screen displayed on a display device by the output control unit 205.

On the display screen shown in FIG. 12, each information which is a server name (server identifier), a type/model of a server machine, a bottleneck resource, a recommended action and a present situation (a resource situation in the present (a part number, a specification, the number of in-use hardware)) is described based on the bottleneck information and the hardware configuration information. Furthermore, as the hardware option effective in dissolving the bottleneck, the information relevant to Items of FIG. 11 is described.

The foregoing operations are automatically executed when performance bottleneck of some kind has occurred in a predetermined managed server 110 of the group of the management servers 100. Accordingly, the user (system manager) may refer to the display screen as shown in FIG. 12, which is finally displayed by the output control unit 205, and may purchase a hardware option necessary to dissolve the bottleneck. Thus, the user needs not to perform a troublesome work to examine the present specs and usage of the system after the bottleneck of the system is detected and to specify a hardware option effective in dissolving the bottleneck.

In the foregoing example, as to Item 1, the replacement of the processor with a higher-speed processor was recommended (see FIG. 7). However, if the system can load more processors than the number of in-use processors in the present, it is also conceived to add new processors to the system without replacing the processor.

Furthermore, as to Item 3, it is recommended to increase a storage capacity of the memory to 512 MB (see FIG. 7). Contrary to this, according to Item 3 of FIG. 11, it is recommended to add one memory having a storage capacity of 128 MB. However, since the system has a room where to load more memories additionally than it loads in the present, the system can load the two memories of 64 MB additionally. Furthermore, if a memory of 512 MB exists, an option that the memory used in the present is replaced with the memory of 512 MB can be considered.

As described above, when there are a plurality of options as an action which can be taken to dissolve the bottleneck, all possible actions and all hardware options for them may be listed, or alternatively based on prices and influences on performance when the recommended action is taken, conditions may be set, and the range of a recommended action and a hardware option, which are displayed, may be narrowed down.

In the foregoing embodiment, when the bottleneck has occurred, the management server 200 inquires of the H/W option information server 400 based on the bottleneck information and the configuration information from the managed server 110, and acquires information relating to a hardware option effective in dissolving the bottleneck, thus notifying the information to the user by displaying it on the display device. Herein, the H/W option information server 400 is provided by a maker of the server machine of the managed server 110, a maker of hardware relevant to the bottleneck resource, and a distributor thereof. On the other hand, buying and selling of the goods are generally performed online by use of Internets nowadays. Accordingly, the provider of the H/W option information server 400 provides a server used for selling of the hardware, whereby it is possible to realize a system and service enabling the hardware option to be purchased instantly from the display screen of the hardware option effective in dissolving the bottleneck, which has been notified to the user.

FIG. 13 is a diagram for explaining a total configuration of a system to which a second embodiment according to the present invention is applied.

The system of this embodiment shown in FIG. 13 comprises a group of operation servers 100, which are to be managed; and a management server 210 for managing managed servers 110 to be managed (hereinafter referred to as “managed server”), which belong to the group of operation servers 100. The management server 210 and the respective managed servers 110 of the group of the operation servers 100 are coupled via a network 120 in the system such as a LAN (Local Area Network). The respective managed servers 110 of the group of the operation servers 100 perform communications with the management server 210, and respectively include a system management agent 111 for exchanging information necessary for the management.

Furthermore, the management server 210 is coupled to a hardware (H/W) option information server 400 and a H/W options selling server 500, which are provided outside the system, via a network 300 such as Internet. The H/W option information server 400 is the same as the H/W option information server 400 shown in FIG. 1. The H/W option selling server 500 sells hardware online in response to a request from the management server 210. In this embodiment, the system for automatically materializing a countermeasure to dissolve bottleneck and for performing a work for performing the countermeasure is constructed by the management server 210, the H/W option information server 400 and the H/W option selling server 500.

The H/W option selling server 500 is a server for selling hardware online, and it is possible to apply an existing system, which performs e-commerce by Internet, to the H/W option selling server 500 directly. Furthermore, the H/W option selling server 500 is realized by a computer apparatus, for example, shown in FIG. 2. Although the H/W option selling server 500 is illustrated by one in FIG. 13, the H/W option selling server 500 is actually provided individually for each managed server 110, a maker of the individual hardware constituting the managed server 110, and a distributor of the hardware. As shown in FIG. 13, the maker and the like of the hardware may provide both of the H/W option information server 400 and the H/W option selling server 500, or alternatively the H/W option information server 400 may be provided by the maker and the H/W option selling server 500 may be provided by the distributor. Although the H/W option information server 400 and the H/W option selling server 500 are illustrated as distinct ones in FIG. 13, such a configuration merely illustrates roles of the H/W option information server 400 and the H/W option selling server 500 in this embodiment. This does not mean that the server of this kind in this embodiment is constituted by a plurality of computer apparatus. Actually, the H/W option information server 400 and the H/W option selling server 500 can be realized by a single computer apparatus.

In the distributed system of this embodiment, a function of each of the managed servers 110 of the group of operation servers 100 is the same as that of each of the managed servers 110 described with reference to FIG. 1 and FIG. 3.

On the other hand, a function of the management server 210 is substantially the same as that of the management server 200 described with reference to FIG. 4. However, the function of the management server 210 is different from that of the management server 200 in that the management server 210 has a function to access the H/W option selling server 500 and purchases hardware online.

FIG. 14 is a diagram showing a functional configuration of the management server 210 in this embodiment.

Referring to FIG. 14, the management server 210 of this embodiment includes a bottleneck information acquisition unit 201, a server configuration information acquisition unit 202, a hardware (H/W) option information acquisition unit 203, an information analysis unit 204, an output control unit 211 and a purchase processing unit 212. In FIG. 14, the bottleneck information acquisition unit 201, the server configuration information acquisition unit 202, the H/W option information acquisition unit 203 and the information analysis unit 204 have the same configurations as those described in FIG. 4. These units are denoted by the same reference numeral as those for the unit in FIG. 4, and description for them are omitted.

The output control unit 211 is, for example, realized by the CPU 11 of FIG. 2, which is controlled by the program, and by the video card 14. The output control unit 211 outputs information relating to a hardware option effective in dissolving a bottleneck which has occurred, and displays this information on a display device, thus notifying this information to the user (system manager). Furthermore, the output control unit 211 displays an input form and a purchase button object, which accept an information input for purchasing a hardware option online.

The purchase processing unit 212 is, for example, realized by the CPU 11 of FIG. 2 which is controlled by the program, a storage device such as the main memory 13 and the magnetic disc device 15, the network interface 16, and an input device such as a keyboard and a mouse. The purchase processing unit 212 accepts data which is inputted in the input form displayed by the output control unit 211, and detects an event generated by clicking of the purchase button object. The purchase processing unit 212 generates a purchase request containing information relating to this input data and the hardware option, and transmits it to the H/W option selling server 500.

Next, an operation of this embodiment in which the management server 210 comprises the purchase processing unit 212 will be described.

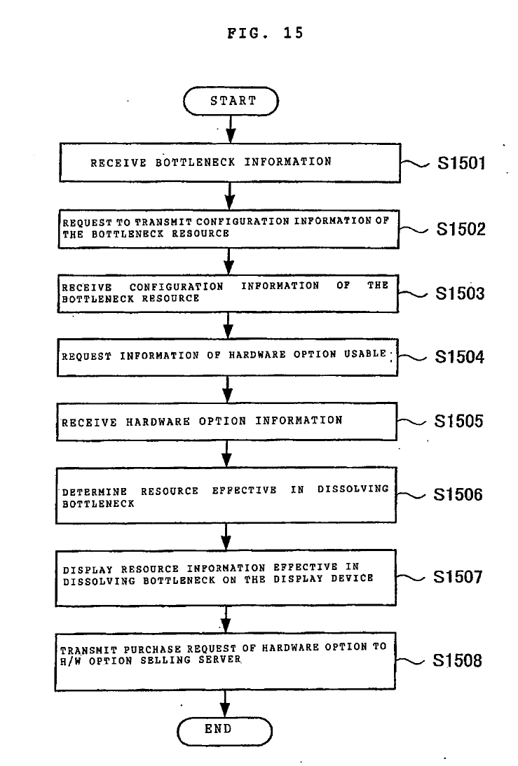

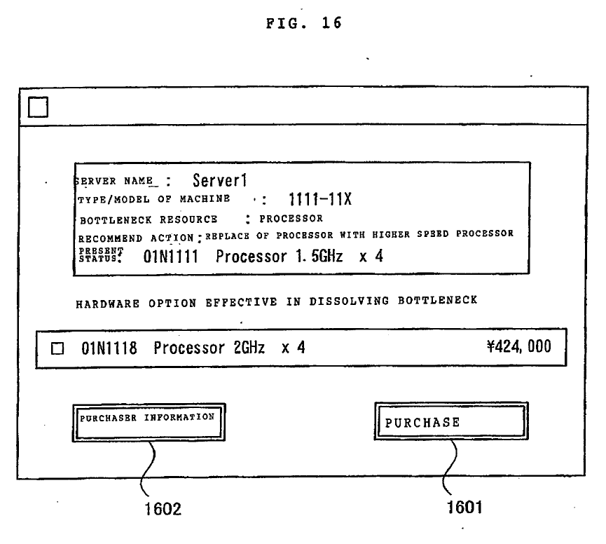

FIG. 15 is a flowchart for explaining an operation of the management server 210 of this embodiment.

In the flowchart of FIG. 15, operations of Steps 1501 through 1506 are the same as those of Steps 601 through 606 shown in FIG. 6.

When a resource effective in dissolving the bottleneck is determined in Step 1506, the output control unit 211 displays information relating to the resource effective in dissolving the bottleneck on the display device, which has been determined by the information analysis unit 204 (Step 1507).

FIG. 16 is a diagram showing a configuration example of a display screen displayed on the display device by the output control unit 211.

As in the case of the display screen shown in FIG. 12, on the display screen shown in FIG. 16, the server name, the type/model of the server machine, the bottleneck resource, the recommended action, the information in the present, and the hardware option effective in dissolving the bottleneck are described. Furthermore, a purchase button object 1601 for purchasing the hardware option by accessing the H/W option selling server 500 and a purchaser information input button object 1602 for displaying an input form to input information relating to a purchaser of the hardware option are described thereon.

In the case where the user (system manager) purchases the hardware option online, the user refers to this display screen, and mouse-clicks the purchaser information input button object 1602, thus allowing the input form to be displayed on the display device. Subsequently, the user inputs information relating to a name of the purchaser, an e-mail address, a payment method and the like. These input items are the same as those performed in ordinarily buying and selling online. These can be determined optionally.

Next, the user checks a check box of a desired hardware option, and mouse-clicks the purchase button object 1601. Upon clicking, the purchase processing unit 212 generates a purchase request containing purchaser information inputted with the input form and information relating the checked hardware option, and transmits it to the H/W option selling server 500 (Step 1508). When the H/W option selling server 500 receives the purchase request, the H/W option selling server 500 executes a processing to close business dealings for the goods (hardware option) concerning the purchase request. Thus, a buying procedure for the hardware option selected by the user is finished. Contents of processing for closing the business dealings in the H/W option selling server 500 are the same as those of processing by servers in ordinary e-commerce. Specifically, a purchasing contract on the hardware option is closed in exchanging information through a network. Then, various methods of cost payments including payments by use of a credit card and payments through a bank transfer are used optionally. And various methods of delivery of goods including delivery by mail and delivery by home-delivery services are used optionally. Note that the purchase information may be stored in the storage device after being once entered, and may be read out from the storage device by the purchase processing unit 212 when the purchase button object 1601 is mouse-clicked. With such a constitution, it is unnecessary to request the user to input the purchaser information every time the user purchases the hardware option, and it is possible to reduce burden of the user.

The foregoing two embodiments described the system which materializes the countermeasure effective in dissolving the bottleneck and which carries out the countermeasures, while focusing on the distributed system comprising the group of operation servers 100 managed by the management servers 200 and 210. However, the application object of the present invention is not limited to such a distributed system.

For example, the present invention can be applied also to a system constituted by various machines (apparatuses) managed collectively by a server having the functions of the management servers 200 and 210 of this embodiment. In this case, it is possible for the server to acquire information relating to a failure part and a part causing a malfunctioning operation from the respective machine as bottleneck information, to acquire information relating to a replacement part for these parts from external server, and to display the information on a display device.

Also in a single computer system different from the distributed system of this embodiment, a low clock speed of a CPU and a shortage of storage capacity of a storage device cause a bottleneck in some cases. Also in this case, in this computer system, the function of the management servers 200 and 210 is realized by a program control, and this embodiment is applied to this computer system. Thus, when a bottleneck occurs, a concrete countermeasure to dissolve the bottleneck by detecting a part causing the bottleneck and by replacing this part can acquire automatically.

Although the preferred embodiments of the present invention have been described in detail, it should be understood that various changes, substitutions and alternations can be made therein without departing from spirit and scope of the inventions as defined by the appended claims.

What is claimed is:

1. A management server for managing a group of one or more operation devices, comprising:
a server information acquisition unit for acquiring information relating to a bottleneck from a device to be managed belonging to the group of one or more operation devices;
a hardware option information acquisition unit for acquiring information on hardware exchangeable for hardware causing the bottleneck; and
an information analysis unit for comparing the information relating to the bottleneck with the information on the hardware exchangeable for the hardware causing the bottleneck and for determining hardware effective in dissolving the bottleneck from among the hardware on which information was acquired by the hardware option information acquisition unit.

2. A management server according to claim 1, further comprising:
an output control unit for outputting the information acquired by the hardware option information acquisition unit which relates to the hardware determined by the information analysis unit and notifying a user of the acquired information.

3. A management server according to claim 2, wherein when a plurality of hardware items effective in dissolving the bottleneck exist which have been determined by the information analysis unit, the output control unit outputs items of enumerated information relating to the hardware.

4. A management server according to claim 1, wherein the hardware option information acquisition unit acquires information on hardware usable to the device to be managed from which the information relating to the bottleneck is acquired, the hardware being the same kind as the hardware causing the bottleneck.

5. A managed server according to claim 1, wherein the information analysis unit selects hardware or a combination thereof which exercises performance capable of achieving a countermeasure for dissolving the bottleneck in response to a content of the information relating to the bottleneck acquired by the server information acquisition unit and determines the hardware effective in dissolving the bottleneck.

6. A management server according to claim I, further comprising:
a purchase processing unit for accepting an input operation by a user and transmitting a request to purchase the hardware effective in dissolving the bottleneck which is selected by the input operation to a server for performing a sale of the hardware online.

7. A management server according to claim 1, wherein the server information acquisition unit includes:
a bottleneck information acquisition unit for acquiring information for specifying the hardware causing the bottleneck and bottleneck information describing a countermeasure effective in dissolving the bottleneck; and
a server configuration information acquisition unit for acquiring configuration information relating to the hardware causing the bottleneck.

8. A management server according to claim 1 in which each of said acquisition units stores information acquired by it in a storage device.

9. A system comprising:
a management server for managing a group of one or more operation devices; and
a hardware option information server for being coupled with the management server through a network and for storing information concerning configurations of respective devices to be managed in the group of one or more operation devices,
wherein the management server includes:
a hardware option information acquisition unit for transmitting to the hardware option information server a request to transmit information on hardware exchangeable for hardware causing a bottleneck in the device to be managed, the hardware that is exchangeable being of the same kind as the hardware causing the bottleneck and being usable to the device to be managed, and for receiving a response to the request from the hardware option information server containing information on the hardware exchangeable for hardware causing the bottleneck; and
an information analysis unit for comparing information relating to a configuration of the device to be managed with the information relating to hardware and for determining hardware which is effective in dissolving a bottleneck in the device to be managed from among the hardware on which information was acquired by the hardware option information acquisition unit, and
wherein the hardware option information server includes:
a hardware information storage unit for storing information relating to hardware which can be used for a device to be managed belonging to the group of one or more operation devices; and
an information retrieval unit for receiving a transmission request which has been transmitted from the hardware option information acquisition unit of the management server, reading out from the hardware information storage unit information relating to hardware which corresponds to the transmission request, and transmitting to the management server the information as a response to the request.

10. A system according to claim 9, wherein the management server further includes an output control unit for outputting the information acquired by the hardware option information acquisition unit which relates to the hardware determined by the information analysis unit and notifying a user of the acquired information.

11. A system according to claim 9, the system further comprising:
a hardware option selling server for performing a sale online of hardware on which information is stored in a hardware information storage unit of the hardware option information server,
wherein the management server further includes a purchase processing unit for accepting an input operation by a user and transmitting a request to purchase the hardware effective in dissolving the bottleneck which is selected by the input operation to the hardware option selling server.

12. A system according to claim 9, wherein the information analysis unit selects hardware or a combination thereof which exercises performance capable of achieving a countermeasure for dissolving the bottleneck in the device to be managed and determines the hardware effective in dissolving the bottleneck.

13. A system according to claim 9, wherein the hardware option information acquisition unit stores information acquired by it in a storage device.

14. A method for managing a group of one or more operation devices, comprising the steps of:
acquiring information relating to a bottleneck from a device to be managed belonging to the group of one or more operation devices;
acquiring information on hardware exchangeable for hardware causing the bottleneck; and
comparing the information relating to the bottleneck with the information on the hardware exchangeable for the hardware causing the bottleneck and determining hardware effective in dissolving the bottleneck from among the hardware on which information was acquired in the second acquiring step.

15. A method according to claim 14, further comprising the step of:
outputting the information acquired in the second acquiring step which relates to the hardware determined effective in dissolving the bottleneck and notifying a user of the acquired information.

16. A method according to claim 14, wherein the second acquiring step comprises the step of:
acquiring information on hardware usable to the device to be managed from which information relating to the bottleneck is acquired, the hardware being of the same kind as the hardware causing the bottleneck.

17. A method according to claim 14, wherein the comparing and determining step comprises the step of:
selecting hardware or a combination thereof which exercises performance capable of achieving a countermeasure for dissolving the bottleneck in response to a content of the information relating to the bottleneck acquired in the first acquiring step and determining the hardware effective in dissolving the bottleneck.

18. A method according to claim 14, further comprising the steps of:
accepting an input operation by a user and transmitting a request to purchase the hardware effective in dissolving the bottleneck which is selected by the input operation to a server for performing a sale of the hardware online.

19. At least one program storage device readable by a machine, tangibly embodying a program of instructions executable by the machine to perform the method steps of claim 14.

20. At least one program storage device according to claim 19, the method steps further comprising:
accepting an input operation by a user and transmitting a request to purchase the hardware effective in dissolving the bottleneck which is selected by the input operation to a server for performing a sale of the hardware online.
